(19) United States
(12) Patent Application Publication
(10) Pub. No.: US 2011/0308684 A1
(43) Pub. Date: Dec. 22, 2011

(54) Tire Having a Ply Border Liner With Low Hysteresis

(75) Inventor: Serge Teisseyre, Soreze (FR)

(73) Assignees: Michelin Recherche et Technique S.A., Granges-Paccot (CH); Societe De Technologie Michelin, Clermont-Ferrand (FR)

(21) Appl. No.: 12/937,239

(22) PCT Filed: Apr. 9, 2009
(86) PCT No.: PCT/EP2009/054317

§ 371 Date: Sep. 6, 2011

(30) Foreign Application Priority Data
Apr. 11, 2008 (FR) 0852450

(51) Int. Cl. B60C 9/00; C08J 3/22

(52) U.S. Cl. 152/451; 523/351

(57) ABSTRACT

The invention relates to a tyre comprising at least one border rubber for one end of a reinforcing element or ply, having a composition based on at least one diene elastomer, a reinforcing filler and a vulcanisation system, characterized in that the composition also includes graphite, in such a way that:
the reinforcing filler content is equal to (A−X) phr and the graphite content is between X/6 and 2X/3 phr;
A being a number between 20 and 120;
X being a number between 4 and 48; and
X and A satisfying the following relationship: X<0.4A.

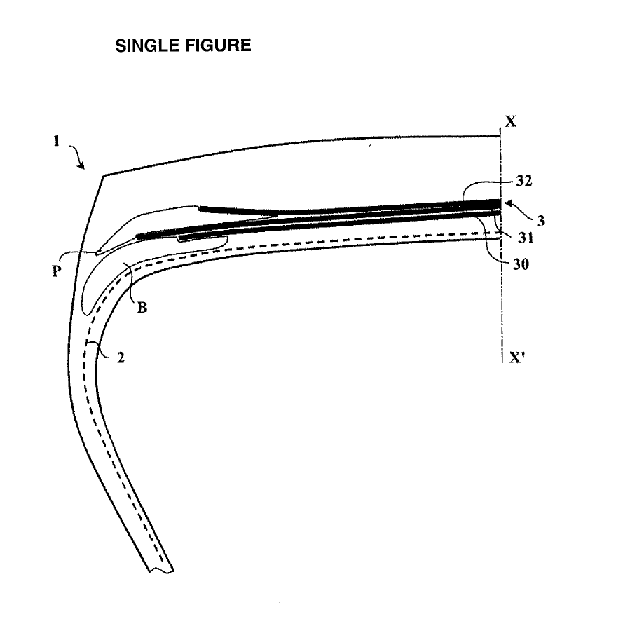

The present invention relates to a tyre with a radial carcass reinforcement and more particularly to a tyre intended for being fitted onto vehicles carrying heavy loads and running at a sustained speed, such as, for example, lorries, tractors, trailers or buses.

The carcass reinforcement is anchored on either side to at least one bead wire and surmounted radially by a crown reinforcement consisting of at least two superposed “working” plies formed from threads or cords that are parallel in each ply and crossed from one ply to the next, making angles of at most 45° in absolute value with the circumferential direction of the tyre. It also generally includes a ply of metal wires or cords of low extensibility making an angle of between 45° and 90° with the circumferential direction, this “triangulation” ply being located radially between the carcass reinforcement and the first “working” crown ply. The triangulation ply forms with the two working plies a triangulated reinforcement which, under the various stresses to which it is subjected, undergoes little deformation, the triangulation ply having the essential role of taking up the transverse compressive forces to which all the reinforcements in the crown zone of the tyre are subjected.

Certain current “road” tyres are designed to run at high speed for ever longer distances, because of the improvement in road networks and the expansion of motorway networks throughout the world. This combination of conditions, under which such a tyre is required to run, undoubtedly increases the mileage of the tyre since it suffers less wear. However, the endurance of the tyre, and in particular that of the crown reinforcement, is greatly reduced.

The stresses existing in the crown reinforcement, and more particularly the shear stresses between the two working crown plies, together with a not insignificant rise in operating temperature at the ends of the shorter working ply, degrade the endurance of the tyre, despite the presence of a thickened rubber layer at the join of the edges of working crown plies. The same problem exists in the case of the edges of two plies of reinforcing elements that are crossed from one ply to the other, said other ply not being necessarily radially adjacent to the first ply.

To remedy the above drawbacks and to improve the endurance of the crown reinforcement of the type of tyre studied, a number of prior patents claim solutions relating to the structure and quality of the layers and/or strips of rubber compounds that are placed in contact with the ends of working plies.

However, it remains difficult for these rubbers or strips placed in contact with the ends of the plies to achieve a compromise for obtaining both an equivalent level of stiffness and improved, i.e. reduced, hysteresis, reducing the extent to which the ply ends are heated.

The Applicant has surprisingly discovered that the use of graphite in a rubber composition intended for rubbers in contact with an inner ply end of a tyre, in a proportion linked to that of the reinforcing filler, makes it possible for such a compromise to be precisely realised.

The invention also relates to rubbers in contact with one end of a reinforcing element making up the carcass reinforcement. Such reinforcing elements may be any type of threadlike reinforcing element capable of reinforcing a specified matrix, for example a rubber matrix. As examples of reinforcing elements, the following may for example be mentioned: multifilament yarns, which may or may not be twisted together; unitary threads, such as cylindrical or oblong monofilaments, which may or may not be twisted together; cords or plied yarns obtained by cabling or twisting operations on these unitary threads or cords, it being possible for such reinforcing elements to be hybrid elements, that is to say composites, comprising elements of different types.

The term “plied yarn” is understood to mean a reinforcing element consisting of single yarns comprising two or more strands joined together by twisting operations; these strands, generally formed from multifilament fibres, are firstly twisted individually in one direction (the S or Z twist direction) during a first twisting step, and then twisted together in the opposite direction (Z or S twist direction, respectively) during a second twisting step.

In what follows, the term “border rubber” denotes a rubber compound positioned in the tyre directly in contact with the end of a reinforcing ply or the end of a reinforcing element. By extension of this definition, the term “border rubber” also denotes a rubber compound positioned in the tyre in contact with a first border rubber as defined above, this first border rubber having a thickness of 2 mm or less, preferably 1.5 mm or less.

The invention relates to a tyre comprising at least one border rubber for one end of a reinforcing element or ply, having a composition based on at least one diene elastomer, a reinforcing filler and a vulcanisation system, characterized in that the composition also includes graphite, in such a way that:
the reinforcing filler content is equal to (A−X) phr and the graphite content is between X/6 and 2×/3 phr;
A being a number between 20 and 120;
X being a number between 4 and 48; and
X and A satisfying the following relationship: X<0.4A.

In particular, the composition of the border rubber includes graphite with a content between 2 and 30 phr, preferably between 3 and 20 phr.

According to one particular embodiment of the invention, the graphite content is equal to X/2. According to another embodiment, the graphite content is equal to X/6.

According to one embodiment of the invention, the diene elastomer is selected from the group formed by polybutadienes, natural rubber, synthetic polyisoprenes, butadiene copolymers, isoprene copolymers and blends of these elastomers. More particularly, the diene elastomer is an isoprene elastomer, preferably a synthetic polyisoprene or natural rubber.

Advantageously, the diene elastomer comprises more than 40 phr natural rubber and/or synthetic polyisoprene.

According to the invention, the graphite is in lamellar form.

In particular, the graphite is a natural graphite, an expandable natural graphite, an expanded graphite or a synthetic graphite, or the graphite comprises a blend of these various graphites.

According to one feature of the invention, the reinforcing filler comprises carbon black, preferably predominantly carbon black and even more preferably the reinforcing filler is formed from carbon black.

According to another feature of the invention, the reinforcing filler comprises an inorganic filler, especially silica.

Another subject of the invention is a process for producing a border rubber for one end of a reinforcing element or ply of a tyre, having a composition based on at least one diene elastomer, a reinforcing filler and a vulcanisation system, characterized in that the composition also includes graphite, in such a way that:
the reinforcing filler content is equal to (A−X) phr and the graphite content is between X/6 and 2×/3 phr;
A being a number between 20 and 120;
X being a number between 4 and 48; and
X and A satisfying the following relationship: X<0.4A,
   said process comprising the following steps:
of incorporating into a diene elastomer at least one reinforcing filler, by thermomechanically mixing all the ingredients, one or more times, until a maximum temperature of between 110° C. and 190° C. is reached;
of cooling the mixture down to a temperature below 100° C.;
of then incorporating the crosslinking system; and
of mixing everything until a maximum temperature below 110° C. is reached.

### I. MEASUREMENTS AND TESTS

The rubber compositions are characterized, before and after curing, as indicated below.

### I-1. Mooney Plasticity

An oscillating consistometer as described in the French standard NF T 43-005 (1991) is used. The Mooney plasticity measurement is carried out according to the following principle: the composition in the green state (i.e. before curing) is moulded in a cylindrical enclosure heated to 100° C. After preheating for one minute, the rotor rotates within the specimen at two revolutions/minute and the useful torque for sustaining this movement is measured after four minutes of rotation. The Mooney plasticity (ML 1+4) is expressed in “Mooney units” (1 MU=0.83 newton.meter).

### I-2. Tensile Tests

These tests are used to determine the elastic stresses and the properties at break. Unless otherwise indicated, they are carried out in accordance with the French standard NF T 46-002 of September 1988. What are called the “nominal” secant moduli (or apparent stresses, in MPa) are measured in second elongation (i.e. after an accommodation cycle) at 10% elongation (denoted “MA10”) and 100% elongation (“MA100”). All these tensile measurements are carried out under standard temperature (23±2° C.) and relative humidity (50±5% RH) conditions according to the French standard NF T 40-101 (December 1979). The stresses at break (in MPa) and the elongations at break (in %) are also measured at a temperature of 23° C.

### I-3. Hysteresis Losses

These losses, denoted by P60°, are measured at 60° C. as a percentage. The deformation for the measured losses is 35%.

### II. DETAILED DESCRIPTION OF THE INVENTION

In the present description, unless expressly indicated otherwise, all the percentages (%) indicated are in wt %. Moreover, any range of values denoted by the expression “between a and b” represents the range of values going from more than a to less than b (i.e. excluding the limits a and b), whereas any range of values denoted by the expression “from a to b” means the range of values going from a up to b (i.e. the limits a and b are strictly included).

### II-1. Diene Elastomer

A “diene” rubber or elastomer must be understood, as is known, to mean an elastomer (or one or more elastomers) at least partly obtained (i.e. a homopolymer or a copolymer) from diene monomers (monomers having two, conjugated or unconjugated, carbon-carbon double bonds).

These diene elastomers may be classified in two categories: “essentially unsaturated” or “essentially saturated”. The term “essentially unsaturated” is generally understood to mean a diene elastomer resulting at least partly from conjugated diene monomers, having a number of units of diene origin (conjugated dienes) that is greater than 15% (mol %); thus diene elastomers such as butyl rubbers or copolymers of dienes and α-olefins of the EPDM type do not fall within the above definition and may in particular be termed “essentially saturated” diene elastomers (content of units of diene origin being low or very low, and always less than 15%). Within the “essentially unsaturated” diene elastomer category, the term “highly unsaturated” diene elastomer is understood in particular to mean a diene elastomer having a number of units of diene origin (conjugated dienes) that is greater than 50%.

Having given these definitions, it will be understood more particularly that a diene elastomer that can be used in the compositions according to the invention means:

(a) any homopolymer obtained by polymerizing a conjugated diene monomer having 4 to 12 carbon atoms;
(b) any copolymer obtained by copolymerizing one or more conjugated dienes with one another or with one or more vinylaromatic compounds having 8 to 20 carbon atoms;
(c) a ternary copolymer obtained by copolymerizing ethylene, an α-olefin having 3 to 6 carbon atoms with an unconjugated diene monomer having 6 to 12 carbon atoms, such as for example the elastomers obtained from ethylene, propylene with an unconjugated diene monomer of the aforementioned type, such as in particular 1,4-hexadiene, ethylidene norbornene and dicyclopentadiene; and
(d) a copolymer of isobutene and isoprene (butyl rubber), and also the halogenated, in particular chlorinated or brominated, versions of this type of copolymer.

Although the present invention applies to any type of diene elastomer, a person skilled in the art of tyres will understand that it is preferably employed with essentially unsaturated diene elastomers, in particular of the type (a) or (b) above.

Suitable conjugated dienes are in particular: 1,3-butadiene, 2-methyl-1,3-butadiene, 2,3-di(C₁-C₅ alkyl)-1,3-butadienes, such as for example 2,3-dimethyl-1,3-butadiene, 2,3-diethyl-1,3-butadiene, 2-methyl-3-ethyl-1,3-butadiene, 2-methyl-3-isopropyl-1,3-butadiene; a 1,3-arylbutadiene, 1,3-pentadiene; and 2,4-hexadiene. Suitable vinylaromatic compounds are, for example: styrene, ortho-, meta- and para-methylstyrene, the commercial “vinyl-toluene” mixture, para-tert-butylstyrene, methoxystyrenes, chlorostyrenes, vinylmesitylene, divinylbenzene and vinylnaphthalene.

The copolymers may contain between 99% and 20% by weight of diene units and between 1% and 80% by weight of vinylaromatic units. The elastomers may have any microstructure, which depends on the polymerization conditions used, in particular the presence or absence of a modifying and/or randomizing agent, and on the amounts of modifying and/or randomizing agent employed. The elastomers may for example be block, random, sequence or microsequence elastomers and may be prepared in dispersion or in solution. They may be coupled and/or star-configured or else functionalized with a coupling and/or star-configuring or functionalizing agent. To couple carbon black, mention may for example be made of functional groups comprising a C—Sn bond or amine functional groups such as for example benzophenone groups; for coupling to a reinforcing inorganic filler such as silica, mention may for example be made of silanol or polysiloxane functional groups having a silanol end (such as those described for example in FR 2 740 778 or U.S. Pat. No. 6,013,718), alkoxysilane groups (as described for example in FR 2 765 882 or U.S. Pat. No. 5,977,238), carboxyl groups (as described for example in WO 01/92402 or U.S. Pat. No. 6,815,473, WO 2004/096865 or US 2006/0089445) or else polyether groups (as described for example in EP 1 127 909 or U.S. Pat. No. 6,503,973). As other examples of functionalised elastomers, elastomers (such as SBR, BR, NR or IR) of the epoxidized type may also be mentioned.

Suitable polymers are polybutadienes, and in particular those having a content (mol %) of -1,2 units between 4% and 80% and those having a content (mol %) of cis-1,4 units greater than 80%, polyisoprenes, butadiene-styrene copolymers and in particular those having a glass transition temperature (T_{g}, measured according to ASTM D3418) of between 0° C. and −70° C. and more particularly between −10° C. and −60° C., a styrene content between 5% and 60%, more particularly between 20% and 50%, by weight, a -1,2 bond content (mol %) of the butadiene part between 4% and 75% and a trans-1,4 bond content (mol %) between 10% and 80%; butadiene-isoprene copolymers and especially those having an isoprene content between 5% and 90% by weight and a T_{g} of from −40° C. to −80° C.; isoprene-styrene copolymers, and especially those having a styrene content between 5% and 50% by weight and a T_{g} between −25° C. and −50° C. In the case of butadiene-styrene-isoprene copolymers, particularly suitable are those having a styrene content between 5% and 50%, more particularly between 10% and 40%, by weight, an isoprene content between 15% and 60%, and more particularly between 20% and 50%, by weight, a butadiene content between 5% and 50%, and more particularly between 20% and 40%, by weight, a content (mol %) of -1,2 units of the butadiene part between 4% and 85%, a content (mol %) of trans-1,4 units of the butadiene part between 6% and 80%, a content (mol %) of -1,2 plus -3,4 units of the isoprene part between 5% and 70% and a content (mol %) of trans-1,4 units of the isoprene part between 10% and 50% and more generally any butadiene-styrene-isoprene copolymer having a T_{g} between −20° C. and −70° C.

To summarize, the diene elastomer of the composition according to the invention is preferably selected from the group of highly unsaturated diene elastomers formed by polybutadienes (BR), synthetic polyisoprenes (IR), natural rubber (NR), butadiene copolymers, isoprene copolymers and blends of these elastomers. Such copolymers are more preferably selected from the group formed by butadiene-styrene (SBR) copolymers, butadiene-isoprene (BIR) copolymers, styrene-isoprene (SIR) copolymers and styrene-butadiene-isoprene (SBIR) copolymers.

According to one particular embodiment, the diene elastomer is predominantly (i.e. more than 50 phr) an SBR, whether an SBR prepared in emulsion (an ESBR) or an SBR prepared in solution (an SSBR), or else an SBR/BR, SBR/NR (or SBR/IR), BR/NR (or BR/IR) blend or an SBR/BR/NR (or SBR/BR/IR) blend. In the case of an SBR elastomer (whether an ESBR or an SSBR), an SBR having a moderate styrene content, for example between 20% and 35% by weight, or a high styrene content, for example 35 to 45%, a content of vinyl bonds of the butadiene part between 15% and 70%, a content (in mol %) of trans-1,4 bonds between 15% and 75% and a T_{g} between −10° C. and −55° C. is especially used. Such an SBR may advantageously be used blended with a BR preferably having more than 90 mol % of cis-1,4 bonds.

According to another particular embodiment, the diene elastomer is predominantly (i.e. with more than 50 phr) an isoprene elastomer. This is in particular the case when the compositions of the invention are intended to form, in tyres, the rubber matrices of certain treads (for example for industrial vehicles), crown reinforcement plies (for example working plies, protective plies or hooping plies), carcass reinforcement plies, sidewalls, beads, protectors, sublayers and blocks of rubber and other internal rubbers providing interfaces between the aforementioned regions of the tyres.

The term “isoprene elastomer” is understood to mean, as is known, either an isoprene homopolymer or an isoprene copolymer, in other words a diene elastomer selected from the group formed by natural rubber (NR), synthetic polyisoprenes (IR), various isoprene copolymers and blends of these elastomers. Among isoprene copolymers, mention may in particular be made of isobutene-isoprene (butyl rubber—IIR) copolymers, styrene-isoprene (SIR) copolymers, butadiene-isoprene (BIR) copolymers and styrene-butadiene-isoprene (SBIR) copolymers. This isoprene elastomer is preferably natural rubber or a synthetic cis-1,4 polyisoprene. Among these synthetic polyisoprenes, it is preferred to use polyisoprenes having a content (in mol %) of cis-1,4 bonds greater than 90%, more preferably still greater than 98%.

According to another particular embodiment, especially when it is intended for a tyre sidewall, having an airtight inner rubber for a tubeless tyre (or another air-impermeable element), the composition according to the invention may contain at least one essentially saturated diene elastomer, in particular at least one EPDM copolymer or a butyl rubber (optionally chlorinated or brominated), whether these copolymers are used singly or blended with highly unsaturated diene elastomers as mentioned above, especially NR or IR, BR or SBR.

According to another preferred embodiment of the invention, the rubber composition comprises a blend of one (or more) “high-T_{g}” diene elastomers having a T_{g} between −70° C. and 0° C. and one (or more) “low-T_{g}” diene elastomers having a T_{g} between −110° C. and −80° C., more preferably between −105° C. and −90° C. The high-T_{g} elastomer is preferably selected from the group formed by S-SBR elastomers, E-SBR elastomers, natural rubber, synthetic polyisoprenes (having a content (in mol %) of cis-1,4 links preferably greater than 95%), BIR elastomers, SIR elastomers, SBIR elastomers and blends of these elastomers. The low-T_{g} elastomer preferably comprises butadiene units with a content (in mol %) of at least 70%. Preferably, it consists of a polybutadiene (BR) having a content (in mol %) of cis-1,4 links of greater than 90%.

According to another particular embodiment of the invention, the rubber composition comprises for example 30 to 100 phr, particularly 50 to 100 phr, of a high-T_{g} elastomer blended with 0 to 70 phr, particularly 0 to 50 phr, of a low-T_{g} elastomer. According to another example, the composition comprises, for all of the 100 phr, one or more SBR elastomers prepared in solution.

According to another particular embodiment of the invention, the diene elastomer of the composition according to the invention comprises a blend of a BR (as low-T_{g} elastomer) with a content (in mol %) of cis-1,4 links greater than 90%, with one or more S-SBR or E-SBR elastomers (as high-T_{g} elastomer(s)).

The compositions of the invention may contain a single diene elastomer or a blend of several diene elastomers, it being possible for the diene elastomer or elastomers to be used in combination with any type of synthetic elastomer other than a diene elastomer, or even with polymers other than elastomers, for example thermoplastic polymers.

### II.2—Reinforcing Filler

Any type of reinforcing filler known for its capability of reinforcing a rubber composition that can be used for manufacturing tyres may be employed, for example an organic filler such as carbon black, a reinforcing inorganic filler, such as silica, or a blend of these two types of filler, especially a carbon black/silica blend.

As carbon blacks, all carbon blacks, especially blacks of the HAF, ISAF and SAF types that are conventionally used in tyres (referred to as tyre-grade blacks) are suitable. Among such blacks, the following may more particularly be mentioned: reinforcing carbon blacks of the 100, 200 or 300 series (ASTM grades), such as for example the blacks N115, N134, N234, N326, N330, N339, N347 and N375, or alternatively, depending on the intended application, blacks of higher series (for example, N660, N683 and N772). The carbon blacks could for example have already been incorporated into the isoprene elastomer in the form of a masterbatch (see for example Patent Applications WO 97/36724 or WO 99/16600).

As examples of organic fillers other than carbon blacks, mention may be made of functionalized polyvinyl aromatic organic fillers as described in Patent Applications WO-A-2006/069792 and WO-A-2006/069793.

The term “reinforcing inorganic filler” should be understood in the present application to mean, by definition, any inorganic or mineral filler, whatever its colour and its origin (natural or synthetic), also called a “white” filler, a “light” filler or even a “non-black filler” as opposed to carbon black, capable by itself of reinforcing, without means other than an intermediate coupling agent, a rubber composition intended for the manufacture of tyres, in other words capable of replacing, in its reinforcing function, a conventional tyre-grade carbon black. Such a filler is generally characterized, as is known, by the presence of hydroxyl (—OH) groups on its surface.

The reinforcing inorganic filler may be in any physical state, i.e. in the form of powder, microspheres, granules, beads or any other appropriate densified form. Of course, it is understood that reinforcing inorganic fillers also include mixtures of various reinforcing inorganic fillers, in particular highly dispersible siliceous and/or aluminous fillers as described below.

Suitable reinforcing inorganic fillers are in particular mineral fillers of the siliceous type, particularly silica (SiO₂), or of the aluminous type, in particular alumina (Al₂O₃). The silica used may be any reinforcing silica known to those skilled in the art, especially any precipitated or pyrogenic silica having a BET surface area and a CTAB specific surface area that are both less than 450 m²/g, preferably ranging from 30 to 400 m²/g. As highly dispersible precipitated silicas (“MS”), the following may for example be mentioned: the silicas Ultrasil 7000 and Ultrasil 7005 from Degussa; the silicas Zeosil 1165 MP, 1135 MP and 1115 MP from Rhodia; the silica Hi-Sil EZ150G from PPG; the silicas Zeopol 8715, 8745 and 8755 from Huber; and silicas having a high specific surface area as described in the Patent Application WO 03/16837.

When the compositions of the invention are intended for treads of low rolling resistance tyres, the reinforcing inorganic filler used, in particular when it is silica, preferably has a BET surface area of between 45 and 400 m²/g, more preferably between 60 and 300 m²/g.

To couple the reinforcing inorganic filler to the diene elastomer, it is known to use an at least difunctional coupling agent (or bonding agent) intended to ensure sufficient connection, of chemical and/or physical nature, between the inorganic filler (the surface of its particles) and the diene elastomer, particularly difunctional organosilanes or polyorganosiloxanes.

Polysulphide-containing silanes, which are either “symmetrical” or “asymmetrical” depending on their particular structure, such as those described for example in Patent Applications WO 03/002648 (or US 2005/016651) and WO 03/002649 (or US 2005/016650), are especially used.

Particularly suitable, without the definition below being limiting, are what are called “symmetrical” polysulphide-containing silanes satisfying the following general formula (I):

Z-A-Sₓ-A-Z, (I)

in which:
x is an integer from 2 to 8 (preferably from 2 to 5);
A is a divalent hydrocarbon radical (preferably C₁-C₁₈ alkylene groups or C₆-C₁₂ arylene groups, more particularly C₁-C₁₀, especially C₁-C₄, alkylene groups, particularly propylene); and
Z satisfies one of the formulae below:

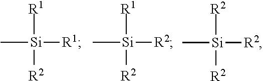

in which:
the radicals R¹, whether substituted or unsubstituted, whether the same or different, represent a C₁-C₁₈ alkyl group, a C₅-C₁₈ cycloalkyl group or a C₆-C₁₈ aryl group (preferably C₁-C₆ alkyl, cyclohexyl or phenyl groups, especially C₁-C₄ alkyl groups, more particularly methyl and/or ethyl); and
the radicals R², whether substituted or unsubstituted, whether the same or different, represent a C₁-C₁₈ alkoxy or C₅-C₁₈ cycloalkoxy group (preferably a group selected from C₁-C₈ alkoxy and C₅-C₈ cycloalkoxy groups, more preferably still a group selected from C₁-C₄ alkoxy groups, particularly methoxy and ethoxy groups).

In the case of a mixture of polysulphide-containing alkoxysilanes satisfying formula (I) above, especially standard commercially available mixtures, the average value of “x” is a fractional number, preferably between 2 and 5, more preferably close to 4. However, the invention may also advantageously be implemented for example with disulphide-containing alkoxysilanes (where x=2).

As examples of polysulphide-containing silanes, mention may more particularly be made of bis((C₁-C₄)alkoxy-(C₁-C₄)alkyl-silyl-(C₁-C₄)alkyl)polysulphides (especially disulphides, trisulphides or tetrasulphides), such as for example bis(3-trimethoxysilylpropyl) polysulphides or bis(3-triethoxysilylpropyl)polysulphides. Among these compounds, bis(3-triethoxysilylpropyl)tetrasulphide, abbreviated to TESPT, of formula [(C₂H₅O)₃Si(CH₂)₃S₂]₂, or bis-(triethoxysilylpropyl)disulphide, abbreviated to TESPD, of formula [(C₂H₅O)₃Si(CH₂)₃S]₂, are in particular used. Mention may also be made, as preferential examples, of bis-((C₁-C₄)monoalkoxyl-(C₁-C₄)dialkylsilylpropyl)polysulphides (especially disulphides, trisulphides or tetrasulphides), more particularly bis(monoethoxydimethylsilylpropyl)tetrasulphide as described in Patent Application WO 02/083782 (or US 2004/132880).

As coupling agent other than a polysulphide-containing alkoxysilane, mention may in particular be made of difunctional POS (polyorganosiloxane) compounds or hydroxysilane polysulphides (R²═OH in formula I above) as described in Patent Applications WO 02/30939 (or U.S. Pat. No. 6,774,255) and WO 02/31041 (or US 2004/051210), or else silanes or POS compounds carrying azo-dicarbonyl functional groups, as described for example in Patent Applications WO 2006/125532, WO 2006/125533, WO 2006/125534.

A person skilled in the art will understand that, as equivalent filler to the reinforcing inorganic filler described in the present text, a reinforcing filler of another, especially organic, nature could be used provided that this reinforcing filler is coated with an inorganic layer, such as a silica layer, or else it includes functional, especially hydroxyl, sites on its surface that require the use of a coupling agent in order to establish the bonding between the filler and the elastomer.

For use of the composition as a border rubber, carbon black in a proportion greater than 20 phr is preferably used as reinforcing filler. Preferably, the carbon black content is between 20 and 120 phr and even more preferably between 20 and 70 phr. It is clear that carbon blacks with a very high ASTM grade, such as the carbon black N990, are less reinforcing than carbon blacks of grade 700 and a fortiori 600, and that it is necessary, for the same level of reinforcement, to use higher carbon black contents when using 900 grade carbon blacks than when using 600 or 700 grade blacks.

Advantageously, carbon black may be the sole reinforcing filler or the predominant reinforcing filler. Of course, it is possible to use a single carbon black or a blend of several carbon blacks of different ASTM grades.

The carbon black may also be used blended with other reinforcing fillers, and in particular with inorganic reinforcing fillers as described above, and particularly with silica.

### II-3 Graphite Filler

The term “graphite” is understood in general to mean an assembly of non-compact hexagonal sheets of carbon atoms, called graphenes. Graphite, of the hexagonal crystal system, comprises a stack of the ABAB type in which the B plane is translated relative to the A plane.

Graphite cannot be considered as a reinforcing filler within the definition specified in section II-2, however it may be considered as a semireinforcing filler insofar as it increases the tensile modulus of a rubber composition into which it is incorporated.

Having given these definitions, a graphite that can be used in the compositions according to the invention will be understood more particularly to be:
(a) any natural graphite, associated with metamorphic rocks, after separating the impurities accompanying graphite veins and after milling;
(b) any thermally expandable natural graphite, i.e. one in which one or more chemical compounds in the liquid state, for example an acid, is (are) interposed between its graphene planes;
(c) any expanded natural graphite, produced in two stages: intercalation of one or more chemical compounds in the liquid state, for example an acid, between the graphene planes of a natural graphite by a chemical treatment followed by high-temperature expansion; or
(d) any synthetic graphite obtained by the graphitization of petroleum coke.

The compositions of the invention may contain a single graphite or a mixture of several graphites. Thus a blend of natural graphite and/or expanded graphite and/or synthetic graphite may be used.

The graphite as defined above may be morphologically in lamellar or non-lamellar form. Surprisingly, it has been found that graphites with either of these two types of morphology are suitable in the compositions according to the invention. However, graphites of lamellar form are very particularly suitable.

The reinforcing filler content is equal to (A−X) phr and the graphite content is between X/6 and 2×/3 phr;
A being a number between 20 and 120;
X being a number between 4 and 48; and
X and A satisfying the following relationship: X<0.4A.

When carbon black is used as predominant reinforcing filler, it has been found that a graphite content equal to X/2 is particularly advantageous for carbon blacks of 100 to 300 grade and that a graphite content of X/6 proves to be particularly advantageous with carbon blacks of higher grade, such as 600 grade blacks.

Preferably, the graphite is present in the composition according to the invention in contents ranging from 2 phr to 30 phr, and more preferably from 3 to 20 phr.

### II-4. Various Additives

The rubber compositions according to the invention may also include some or all of the standard additives conventionally used in elastomer compositions intended for the manufacture of tyres or semifinished products for tyres, such as for example other plasticizers (other than the plasticizing system of the invention), preferably non-aromatic to or very slightly aromatic plasticizers, for example naphthenic oils, paraffinic oils, MES or TDAE oils, glycerol esters (particularly trioleates), especially natural esters such as rapeseed or sunflower vegetable oils, pigments, protection agents such as anti-ozonants and antioxidants, anti-fatigue agents, a crosslinking system based either on sulphur or on donors of sulphur and/or peroxide and/or bismaleimide, vulcanization accelerators, vulcanization activators and antireversion agents.

These compositions may also contain, in addition to the coupling agents, coupling activators or covering agents for the inorganic fillers or more generally processing aids that are capable, as is known, thanks to an improvement in the dispersion of the filler in the rubber matrix and to a lowering of the viscosity of the compositions, of improving their processability in the green state, these agents being for example hydrolysable silanes, such as alkylalkoxysilanes, polyols, polyethers, primary, secondary or tertiary amines, and hydroxylated or hydrolysable polyorganosiloxanes.

### II-5. Manufacture of the Rubber Compositions

The compositions are manufactured in suitable mixers, using two successive preparation steps well known to those skilled in the art, namely a first, thermomechanical working or kneading step at high temperature, up to a maximum temperature of between 110° C. and 190° C., preferably between 130° C. and 180° C., followed by a second, mechanical working step up to a lower temperature, typically below 110° C., for example between 40° C. and 100° C., during which finishing step the crosslinking system is incorporated.

The process according to the invention for producing a rubber composition for a tyre inner rubber comprises the following steps:
of incorporating into an elastomer at least one reinforcing filler and graphite during a first step, by thermomechanically mixing all the ingredients, one or more times, until a maximum temperature of between 110° C. and 190° C. is reached;
of then incorporating a crosslinking system during a second step; and
of mixing everything until a maximum temperature below 110° C. is reached.

These two steps may be carried out one after each other using the same mixer or may be separated by a cooling step down to a temperature below 100° C., the final step then being carried out using a second mixer.

To give an example, the first phase is carried out in a single thermomechanical step during which all the necessary basic constituents (elastomer, reinforcing filler and coupling agent if necessary and graphite) are firstly introduced into a suitable mixer, such as a standard internal mixer, and then secondly, for example after one to two minutes of mixing, the other additives, optional covering agents or complementary processing aids, with the exception of the crosslinking system, are introduced. After the mixture thus obtained has cooled, the crosslinking system is then incorporated in an external mixer, such as a two-roll mill, maintained at low temperature (for example between 40° C. and 100° C.). All the ingredients are then mixed for a few minutes, for example between 2 and 15 minutes.

The crosslinking system is preferably a vulcanization system based on sulphur and an accelerator. It is possible to use any compound that can act as a vulcanization accelerator for elastomers in the presence of sulphur, in particular those chosen from the group formed by 2-mercaptobenzothiazyl disulphide (abbreviated to MBTS), N-cyclohexyl-2-benzothiazyl sulphenamide (abbreviated to CBS), N,N-dicyclohexyl-2-benzothiazyl sulphenamide (abbreviated to DCBS), N-tert-butyl-2-benzothiazyl sulphenamide (abbreviated to TBBS), N-tert-butyl-2-benzothiazyl sulphenimide (abbreviated to TBSI) and mixtures of these compounds. Preferably, a primary accelerator of the sulphenamide type is used.

Various known secondary accelerators or vulcanization activators, such as zinc oxide, stearic acid, guanidine derivatives (in particular diphenylguanidine), etc., are added to this vulcanization system during the first step and/or during the second step.

The final composition thus obtained is then calendered, for example in the form of a sheet, especially for laboratory characterization, or else extruded in the form of a rubber profiled strip that can be used as a tyre border rubber.

The vulcanization (or curing) is carried out, in a known manner, generally at a temperature of between 130° C. and 200° C. for a sufficient time, which may vary for example between 5 and 90 minutes, depending in particular on the curing temperature, the vulcanization system adopted and the rate of vulcanization of the composition in question.

The invention relates to the rubber compositions described above both in what is called the “green” state (i.e. before curing) and in what is called the “cured” or vulcanized state (i.e. after vulcanization).

### III. EXAMPLES OF THE IMPLEMENTATION OF THE INVENTION

The following examples serve to illustrate the invention, the latter however not being limited to just these examples.

The implementation example illustrated by the single FIGURE shows two examples of border rubbers P and B of working ply ends of a tyre, the single FIGURE being a partial view in meridian cross section of a schematic representation of a tyre.

### III-1 Positioning of the Border Rubbers B and P in the Tyre

The FIGURE shows only a half-view of a tyre, this extending symmetrically with respect to the XX′ axis that represents the circumferential mid-plane, or equatorial plane, of a tyre.

The tyre 1 comprises a radial carcass reinforcement composed of a single ply 2 of inextensible metal cords, that is to say cords having elongation of at most 0.2% under a tensile force equal to 10% of the rupture force. Said carcass reinforcement is anchored in each bead (said beads not being shown in the FIGURE) and is radially to the outside, surmounted by a crown reinforcement 3 comprising, radially from the inside to the outside:
a first, “triangulation” crown ply 30 formed from inextensible steel cords, the end of this first ply covering a border rubber B that extends partly parallel with the ply 2;
radially surmounting said ply 30, a first working crown ply 31 formed from inextensible steel cords;
radially to the outside and in contact with the working crown ply 31, a second border rubber P, called “decoupling” rubber, covering the end of said working ply 31; and then
a second working crown ply 32 formed from steel cords identical to those of the first ply 31.

### III-2 Preparation of the Rubber Compositions of Border Rubbers B and P

The procedure for the trials was the following: the reinforcing filler, the graphite, the diene elastomer and various other optional ingredients, with the exception of the vulcanization system, were introduced in succession into an internal mixer, filled to 75%, the initial barrel temperature of which was about 60° C. The mixture was then thermomechanically worked in one step which lasted in total about 3 to 4 minutes, until a maximum “drop” temperature of 160° C. was reached.

The mixture thus obtained was recovered, cooled and then sulphur and a sulphenamide-type accelerator incorporated thereinto on an external mixer (homo-finisher) at 30° C., all the ingredients being mixed for a suitable time (for example between 5 and 12 minutes).

The composition thus obtained was then extruded in the form of a tyre rubber profiled strip.

### III-3 Rubber Trials

The objective of these trials was to demonstrate the improved isorigidity/hysteresis compromise for border rubbers B and P as described above according to the invention, i.e. the composition of which contains graphite and carbon black in a relative content corresponding to the equations mentioned in the present patent application, compared with control border rubbers containing only carbon black.

### Trial 1

The compositions of the control border rubbers are denoted by B1 and P1 and the border rubbers according to the invention are denoted by B2 and P2, the references B and P corresponding to the information given in section III-1.

These four compositions B1, P1, B2 and P2 were produced in accordance with the process described in detail in the above section; compositions B1 and B2 on the one hand and P1 and P2 on the other had, respectively, the same base formulation b on the one hand and base formulation p on the other, these formulations b and p being given below (the quantities being expressed in phr, i.e. parts per hundred parts of rubber):

Formulation

| | b | p |
|---|---|---|
| Elastomer (1) | 100 | 100 |
| Zinc oxide | 5 | 9 |
| Stearic acid | 0.5 | 0.6 |
| Antioxidant (2) | 1.5 | 1.8 |
| DPG (3) | 0.35 | — |
| CTP (4) | — | 0.4 |
| Accelerator (5) | 0.5 | 0.7 |
| Sulphur | 2 | 6 |

(1) Natural rubber;
(2) Antioxidant: 6PPD;
(3) DPG: diphenylguanidine;
(4) CTP: cyclohexyl-thiophthalimide; and
(5) N-tert-butyl-2-benzothiazyl sulphenamide, TBBS.

The differences in formulation of compositions B1, B2, P1 and P2 are given in Table 1 below:

TABLE 1

Composition

| | B1 | B2 | P1 | P2 |
|---|---|---|---|---|
| Carbon black (6) | 25 | 20 | — | — |
| Carbon black (7) | — | — | 50 | 35 |
| Graphite (8) | — | 2.5 | — | 7 |

(6) Carbon black N115;
(7) Carbon black N347;
(8) Natural graphite: TIMREX BNB90 sold by Timcal.

The rubber properties of these four compositions were measured before and after curing at 150° C. for 60 minutes, the results obtained being given in Table 2.

TABLE 2

Composition

| | B1 | B2 | P1 | P2 |
|---|---|---|---|---|
| Properties before curing | | | | |
| Mooney | 73 | 65 | 72 | 54 |
| Properties after curing | | | | |
| MA10 (MPa) | 2.43 | 2.73 | 9.40 | 8.99 |
| MA100 (MPa) | 1.02 | 1.32 | 4.30 | 3.80 |
| P60° | 16.9 | 12.3 | 26.2 | 21.6 |

This table shows that compositions B2 and P2 according to the invention, that is to say those containing graphite in a proportion related to the proportion of carbon black (as explained in greater detail earlier in the description), has better processability than the corresponding control compositions, equivalent elongation properties in the cured state and above all, surprisingly, a significant reduction in hysteresis (see P60°).

Thus, it is clearly apparent that the compositions according to the invention make it possible to improve the hysteresis compared with control compositions and, because of their positions at the end of reinforcing elements or plies, these compositions according to the invention reduce the heating at these ends.

### Trial 2

In this trial, decoupling border rubbers P were compared, such as those described in section III-1, the formulation of which includes a 600 grade carbon black.

Composition P′1 for a control border rubber and composition P′2 the control border rubber P′1 were prepared in accordance with the process described in detail in section III-2, compositions P′1 and P′2 having the same following base formulation p′ (the quantities are expressed in phr, i.e. parts per hundred parts of rubber):

| | Formulation |
|---|---|
| | p′ |
| Elastomer (1) | 100 |
| Zinc oxide | 9 |
| Stearic acid | 1 |
| Antioxidant (2) | 1.3 |
| CTP (4) | 0.8 |
| Accelerator (9) | 0.5 |
| Sulphur | 2 |

(1) Natural rubber;
(2) 6PPD;
(4) CTP: cyclohexyl-thiophthalimide; and
(9) N,N-dicyclohexyl-2-benzothiazyl sulphenamide DCBS.

The differences in formulation of compositions P′1 and P′2 are given in Table 3 below:

TABLE 3

Composition

| | P′1 | P′2 |
|---|---|---|
| Carbon black (10) | 53 | 34 |
| Graphite (8) | — | 3.5 |

(10) N683 carbon black; and
(8) Natural graphite: TIMREX BNB90 sold by Timcal.

The rubber properties of these two compositions were measured before and after curing at 150° C. for 60 minutes, the results obtained being given in Table 4.

TABLE 4

Composition

| | P′1 | P′2 |
|---|---|---|
| Properties before curing | | |
| Mooney | 73 | 53 |
| Properties after curing | | |
| MA10 (MPa) | 9.36 | 9.03 |
| MA100 (MPa) | 5.77 | 5.06 |
| P60° | 14.5 | 13.0 |

This table shows that composition P′2 according to the invention, i.e. containing graphite in a proportion related to the proportion of carbon black (as explained in greater detail earlier in the description), has better processability than the control composition P′1, equivalent elongation properties in the cured state and a significant reduction in hysteresis (see P60°).

Thus, it is clearly apparent that the composition according to the invention using a carbon black grade different from those in trial 1 also makes it possible to improve the hysteresis compared with a control composition using a reinforcing filler of the same type.

1. A tire comprising at least one border rubber for one end of a reinforcing element or ply, the border rubber having a composition based on at least one diene elastomer, a reinforcing filler and a vulcanization system, wherein the composition further comprises graphite, in such a way that:
the reinforcing filler content is equal to (A−X) phr and the graphite content is between X/6 and 2×/3 phr;
A being a number between 20 and 120;
X being a number between 4 and 48; and
X and A satisfying the following relationship: X<0.4A.

2. The tire according to claim 1, wherein the composition of the border rubber includes graphite with a content between 2 and 30 phr.

3. The tire according to claim 1, wherein the composition of the border rubber includes graphite with a content between 3 and 20 phr.

4. The tire according to claim 1, wherein the graphite content is equal to X/2.

5. The tire according to claim 1, wherein the graphite content is equal to X/6.

6. The tire according to claim 1, wherein the diene elastomer is selected from the group consisting of polybutadienes, natural rubber, synthetic polyisoprenes, butadiene copolymers, isoprene copolymers and blends of these elastomers.

7. The tire according to claim 1, wherein the diene elastomer is an isoprene elastomer.

8. The tire according to claim 7, wherein the diene elastomer comprises more than 40 phr natural rubber and/or synthetic polyisoprene.

9. The tire according to claim 1, wherein the graphite is in lamellar form.

10. The tire according to claim 1, wherein the graphite is a natural graphite.

11. The tire according to claim 1, wherein the graphite is an expandable natural graphite.

12. The tire according to claim 1, wherein the graphite is an expanded graphite.

13. The tire according to claim 1, wherein the graphite is a synthetic graphite.

14. The tire according to claim 1, wherein the graphite comprises a blend of natural graphite and/or expandable natural graphite and/or expanded graphite and/or synthetic graphite.

15. The tire according to claim 1, wherein the reinforcing filler comprises carbon black.

16. The tire according to claim 15, wherein the reinforcing filler comprises predominantly carbon black.

17. The tire according to claim 16, wherein the reinforcing black filler is formed from carbon black.

18. The tire according to claim 1, wherein the reinforcing filler comprises an inorganic filler.

19. The tire according to claim 18, wherein the inorganic filler is silica.

20. A process for producing a border rubber for one end of a reinforcing element or ply of a tire, having a composition based on at least one diene elastomer, a reinforcing filler and a vulcanization system, wherein the composition further comprises graphite, in such a way that:
the reinforcing filler content is equal to (A−X) phr and the graphite content is between X/6 and 2×/3 phr;
A being a number between 20 and 120;
X being a number between 4 and 48; and
X and A satisfying the following relationship: X<0.4A,
said process comprising the following steps:
incorporating into a diene elastomer at least one reinforcing filler, by thermomechanically mixing all the ingredients, one or more times, until a maximum temperature of between 110° C. and 190° C. is reached;
cooling the mixture down to a temperature below 100° C.;
then incorporating a vulcanization system; and
mixing everything until a maximum temperature below 110° C. is reached.

21. The tire according to claim 7, wherein the isoprene elastomer comprises a synthetic or natural rubber.
